(19) United States
(12) Patent Application Publication
(10) Pub. No.: US 2008/0293374 A1
(43) Pub. Date: Nov. 27, 2008

(54) METHOD AND APPARATUS FOR TRANSMITTING EMERGENCY ALERT MESSAGES

(75) Inventor: VIRGINIA BERGER, SAN ANTONIO, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/754,064

(22) Filed: May 25, 2007

(51) Int. Cl. H04M 11/04

(52) U.S. Cl. 455/404.2

(57) ABSTRACT

A method and apparatus for transmitting emergency alert messages is disclosed. A system that incorporates teachings of the present disclosure may include, for example, a cellular phone having a transceiver to engage in wireless voice and data communications with third party communication devices, a global positioning system receiver to locate the cellular phone, a user interface for displaying images, detecting tactile input, and generating and receiving audible signals, and a controller to manage operations of the cellular phone. The controller can present at the user interface a graphical user interface for selectively configuring at least one among a plurality of security alarm options, receive from the user interface a selection of one among the plurality of security alarm options, and activate the selected security alarm option responsive to a stimulus detected by the user interface. Additional embodiments are disclosed.

### FIELD OF THE DISCLOSURE

The present disclosure relates generally to communication systems, and more specifically to a method and apparatus for transmitting emergency alert messages.

### BACKGROUND

Emergency situations can arise from a number of circumstances. For example, an individual can be involved in a car accident, or medical emergency. A dangerous situation can also arise from an individual being victimized by an unlawful act such as a robbery or burglary. Victims who carry cell phones can often call an emergency response center by dialing 911 in the United States. However, there are circumstances in which dialing 911 may not be possible such as for example when a person cannot readily speak, or dial 911. There are also occasions where it would be desirable to use a deterrent to ward off danger.

A need therefore arises for a method and apparatus for transmitting emergency alert messages.

### BRIEF DESCRIPTION OF THE DRAWINGS

FIG. 1 depicts an exemplary embodiment of a communication system;

FIG. 2 depicts an exemplary embodiment of a communication device operating in the communication system;

FIG. 3 depicts an exemplary method operating in portions of the communication system; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for transmitting emergency alert messages.

In a first embodiment of the present disclosure, a cellular phone can have a transceiver to engage in wireless voice and data communications with third party communication devices, a Global Positioning System (GPS) receiver to locate the cellular phone, a user interface for displaying images, detecting tactile input, and generating and receiving audible signals, and a controller to manage operations of the cellular phone. The controller can present at the user interface a Graphical User Interface (GUI) for selectively configuring at least one among a plurality of security alarm options, receive from the user interface a selection of one among the plurality of security alarm options, and activate the selected security alarm option responsive to a stimulus detected by the user interface.

In a second embodiment of the present disclosure, a computer-readable storage medium in a communication device can have computer instructions for presenting a Graphical User Interface (GUI) for selectively configuring at least one among a plurality of security alarm options, and activating the selected security alarm option responsive to an audible or tactile stimulus.

In a third embodiment of the present disclosure, a monitoring system can have a controller element to receive an emergency alert signal from a cell phone having a plurality of configurable security alert options.

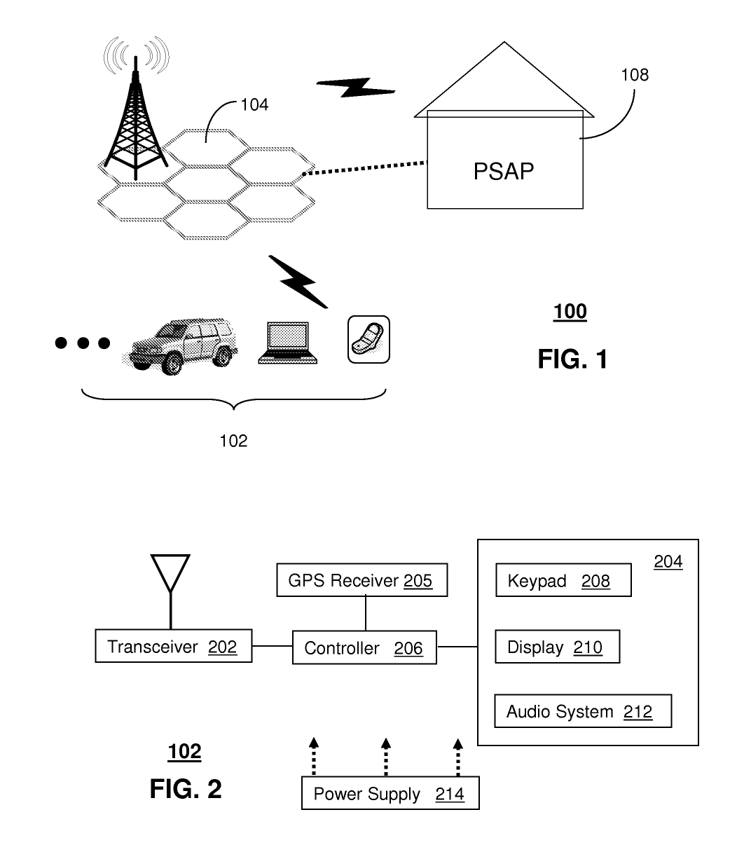

FIG. 1 depicts an exemplary embodiment of a communication device 102 operating in a communication system 100. The communication device 102 can be represented by a cellular phone, laptop or desktop computer, a communication system in an automobile (such as a telemetry system), or a that set-top box that can present multimedia services via a television set as well as provide video and voice communications. The communication device 102 can utilize any one of a number of access technologies to communicate with a base station 104 including without limitation CDMA-1X, UMTS/HSDPA, GSM/GPRS, TDMA/EDGE, EV/DO, PSTN, VoIP, WiMAX, and next generation technologies as they arise. By way of the base station 104, the communication device 102 can establish communications with a Public Service Access Point (PSAP) 108 which serves as an emergency response center for fire, police and other emergency services.

FIG. 2 depicts an exemplary embodiment of the communication device 102. The communication device 102 can comprise a wireless transceiver 202, a user interface (UI) 204, a Global Positioning System (GPS) receiver, a power supply 214, and a controller 206 for managing operations thereof. The wireless transceiver 202 utilizes common communication technology that supports the aforementioned access technologies. The UI 204 can include a depressible or touch-sensitive keypad 208 for manipulating operations of the communication device 102. The UI 204 can further include a display 210 such as monochrome or color LCD (Liquid Crystal Display) for conveying images to the end user of the communication device 102. The audio system 212 of the UI 204 utilizes common audio technology for conveying and receiving audible signals of the end user. The audio system 212 can also support a speakerphone function for hands-free operations.

The GPS receiver 205 can utilize common technology for processing signals from a constellation of satellites to determine a geographic location of the communication device 102. The power supply 214 can utilize common power management technologies (such as replaceable batteries, supply regulation technologies, and charging system technologies) for supplying energy to the components of the communication device 102 to facilitate portable applications. The controller 206 can utilize computing technologies such as a microprocessor and/or digital signal processor (DSP) with associated storage memory such a Flash, ROM, RAM, SRAM, DRAM or other like technologies.

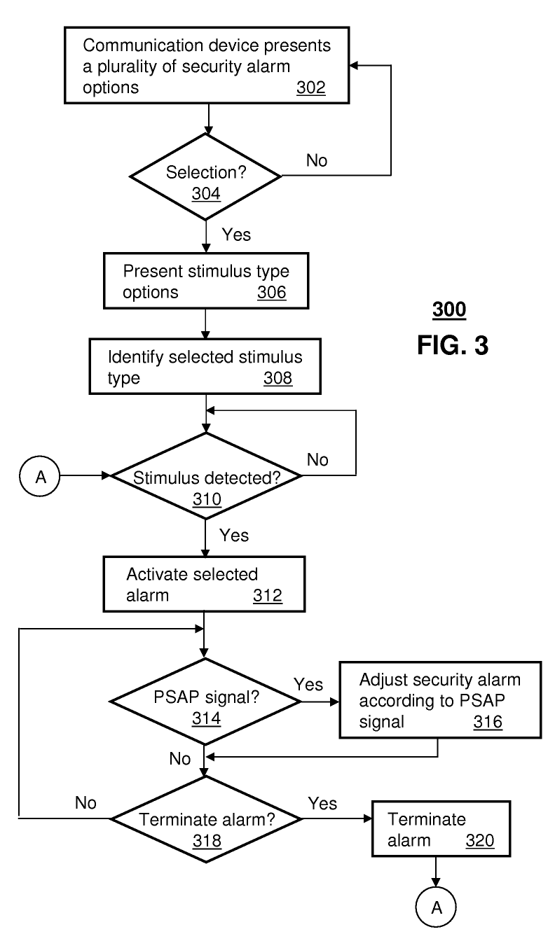

FIG. 3 depicts an exemplary method 300 operating in portions of the communication system 100. Method 300 begins with step 302 in which the communication device 102 presents a Graphical User Interface (GUI) by way of the UI 204 with a plurality of security alarm options to protect a user of the communication device 102 from dangerous conditions (e.g., fire hazard, accident, medical emergency, mugger, prowler, etc.). The GUI can present a drop-down menu or windows for presenting the security options.

In one embodiment, a high volume audible alarm can be presented as one of the security options. The high volume audible alarm can represent a high pitch steady-state tone (such as a screeching siren) or a varying tone such as that used by emergency vehicles played by way of a loud speaker of the audio system 212 to capture the attention of others and/or ward off danger. Alternatively, or in combination the high volume audible alarm can represent a speech message played by way of the speakerphone feature that indicates to listeners in the vicinity of the communication device 102 that emergency response personnel have been contacted and are on their way.

Another security alarm option can be an alarm signal transmitted by way of the transceiver 202 to the PSAP 108 that includes a GPS coordinate of the communication device and/or a party identification. The GPS coordinate can indicate a location of the communication device 102 so that emergency personnel can readily locate the user of said device. The party identification can represent subscriber information such as the identity of the subscriber, an age of the subscriber, a gender of the subscriber, and/or medical information (e.g., medical history) associated with the subscriber.

Alternatively or in combination, the communication device 102 can support an option in which a security alert triggers a two-way voice communication session with the PSAP 108. The two-way communication can be a stealth-mode communication in which the UI 204 is muted to prevent a party from detecting that an agent of the PSAP 108 is privy to listening to audible signals in the vicinity of the communication device 102. In a non-stealth mode, the UI 204 is fully enabled with the speakerphone feature for hands-free communication.

Referring back to FIG. 3, if a selection is detected in step 304, the communication device 102 proceeds to step 306; otherwise, it waits for a selection or times out. Once a security alert option has been selected in step 304, the communication device 102 presents in step 306 a plurality of stimulus type options for triggering the selected security alert. The stimulus type can be, for example, an audible or tactile stimulus or a combination thereof. An audible stimulus can represent one or more speech commands which can be stealth (e.g., “Where are you taking me”) or direct commands (“help”, “call 911”). A tactile stimulus can represent one or more depressions of the keypad or other buttons of the communication device 102 (e.g., a dedicated emergency button which needs to be depressed 4 seconds to avoid false positives, a 4 second simultaneous depression of the * and # keys, etc.). Audible and/or tactile stimuli can be predefined and presented to a user by the UI 204, and/or can be customized by the user of the communication device 102. Accordingly, the communication device 102 can be programmed to monitor user-defined or predefined stealth or non-stealth speech commands, or tactile combinations.

In step 310, the communication device 102 is programmed to monitor for a triggering event corresponding to a selected stimulus type identified in step 308. If a stimulus is not detected, the communication device 102 continues the monitoring process. Once a stimulus (audible and/or tactile) is detected, the communication device 102 proceeds to step 312 where it activates the selected security alarm. As noted earlier the security alarm can be a high volume audible signal generated by a loud speaker of the communication device 102, and/or two-way or one-way communications with the PSAP 108 with GPS and/or identification information submitted thereto.

For example, a user in the midst of a robbery can say “please do not hurt me”, which in turn triggers a stealth call to the PSAP 108. In this instance, the PSAP 108 has a GPS location fix of the communication device 102 to promptly locate the subscriber. The emergency call also identifies the subscriber as John Doe, age 42, which suffers from heart conditions. An agent of the PSAP 108 can hear what is being said by the victim and the assailant, determine the assailant's gender and possible age, but cannot be heard since the UI 204 has been muted. With this information, the agent can assess the level of danger and can inform the nearest police officer where to proceed and what to expect as well as request an ambulance in the event a serious medical condition develops due to the stress placed on the victim.

In step 314, the communication device 102 can be programmed to monitor signals from the PSAP 108. Such signals can be used by the PSAP 108 to direct the communication device 102 to adjust in step 316 the security alarm state of the communication device 102. For example, a sequence of one or more predetermined Dual Tone Multi-Frequency (DTMF) tones (e.g., **88) can be entered by an agent of the PSAP 108 to remove a muted UI 204 and enable the speakerphone feature of the UI so that the agent can convey a message to the assailant or victim in the above example (e.g., “This is the police department. A police officer has been dispatched to your location. Drop your weapon and do not harm Mr. Doe”).

In step 318 the communication device 102 can monitor a request to terminate the security alarm. If a termination signal is detected, the communication device proceeds to step 320 where it terminates the alarm as requested. The termination signal can arise from an audible or tactile input presented to the communication device 102. Alternatively, the termination signal can be transmitted by the PSAP 108 by way of a sequence of DTMF tones or other suitable signals detectable by the communication device 102. Once the alarm is terminated, the communication device 102 proceeds to step 310 where it monitors for a subsequent reassertion of the selected security alarm.

From the foregoing descriptions, it would be evident to an artisan with ordinary skill in the art that the aforementioned embodiments can be modified, reduced, or enhanced without departing from the scope and spirit of the claims described below. For example, method 300 can be utilized to address hazards (e.g., fire, highway accident), or health emergencies (e.g., heart attack, epilepsy attack). A communication device 102 such as a flip cellular phone can be in a closed position and perform the steps described in method 300 to avoid the appearance that it is being used during dangerous situations such as a robbery. Additionally, method 300 can be applied in situations where the subscriber is situated at a residence or in a commercial establishment using a PSTN phone, set-top box, computer, or other communication-capable device that performs the functions of method 300. The PSAP 108 can also be replaced by a monitoring system which is commercially managed by an emergency response center.

These are but a few examples of how the embodiments described herein can be updated without altering the scope of the claims below. Accordingly, the reader is directed to the claims for a fuller understanding of the breadth and scope of the present disclosure.

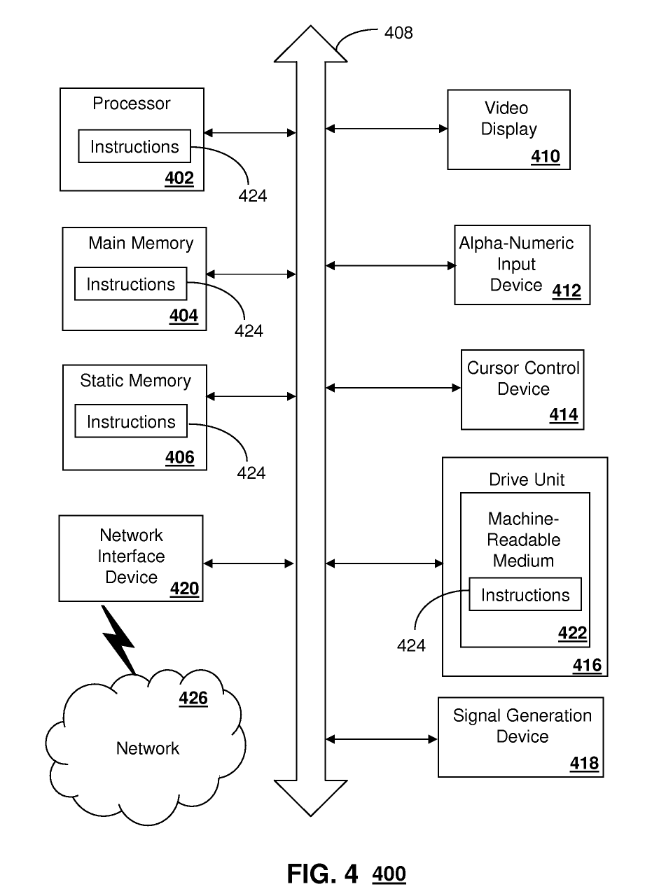

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A cellular phone, comprising:
a transceiver to engage in wireless voice and data communications with third party communication devices;
a Global Positioning System (GPS) receiver to locate the cellular phone;
a user interface for displaying images, detecting tactile input, and generating and receiving audible signals; and
a controller to manage operations of the cellular phone, and to:
present at the user interface a Graphical User Interface (GUI) for selectively configuring at least one among a plurality of security alarm options;
receive from the user interface a selection of one among the plurality of security alarm options; and
activate the selected security alarm option responsive to a stimulus detected by the user interface.

2. The cellular phone of claim 1, wherein the user interface comprises a display, a keypad, and an audio system for detecting and presenting audible signals, wherein the stimulus comprises one among a tactile input and an audible speech signal received by the user interface, and wherein the controller presents a second GUI for selecting a stimulus type for the selected security alarm option.

3. The cellular phone of claim 2, wherein the controller receives a selection of the stimulus type, and at least one or more speech commands when the stimulus type corresponds to an audible stimulus, and one or more tactile inputs when the stimulus type corresponding to a tactile stimulus.

4. The cellular phone of claim 1, wherein the plurality of security alarm options comprises a high volume audible alarm, an alarm signal transmitted by way of the transceiver to a Public Service Access Point (PSAP) comprising at least one among a GPS coordinate and a party identification, a two-way voice communication session with the PSAP, and a transmit-only voice communication session with the PSAP.

5. The cellular phone of claim 1, wherein the controller transmits a geographic location fix of the cellular phone to a PSAP responsive to the detected stimulus.

6. The cellular phone of claim 5, wherein the controller transmits subscriber information with the geographic location fix.

7. The cellular phone of claim 6, wherein the subscriber information comprises at least one among an identity of the subscriber of the cellular phone, an age of the subscriber, a gender of the subscriber, and medical information associated with the subscriber.

8. The cellular phone of claim 5, wherein the controller activates a high volume audible alarm responsive to the detected stimulus.

9. The cellular phone of claim 8, wherein the high volume audible alarm comprises at least one among a high pitch steady-state or varying tone, a speech message that indicates emergency response personnel have been contacted.

10. The cellular phone of claim 5, wherein the controller establishes a two-way voice communication session with the PSAP and enables a speakerphone feature of the user interface to engage in hands-free communications.

11. The cellular phone of claim 5, wherein the stimulus detected corresponds to a stealth mode emergency request, and wherein the controller:
establishes a two-way voice communication session with the PSAP; and
mutes the user interface to prevent a presentation of audible signals received from the PSAP.

12. The cellular phone of claim 11, wherein the controller enables the user interface to present audible signals received from the PSAP responsive to receiving one or more predetermined Dual Tone Multi-Frequency (DTMF) tones from the PSAP.

13. The cellular phone of claim 1, wherein the controller disables the selected security alarm option responsive to at least one among one or more tactile or audible signals received by the user interface, or a signal transmitted by the PSAP.

14. A computer-readable storage medium in a communication device, comprising computer instructions for:
presenting a Graphical User Interface (GUI) for selectively configuring at least one among a plurality of security alarm options; and
activating the selected security alarm option responsive to an audible or tactile stimulus.

15. The storage medium of claim 14, comprising computer instructions for transmitting a geographic location fix to a Public Service Access Point (PSAP).

16. The storage medium of claim 14, wherein the plurality of security alarm options comprises a high volume audible alarm, an alarm signal transmitted by way of the transceiver to a PSAP, the alarm signal comprising at least one among a GPS coordinate and a party identification, a two-way voice communication session with the PSAP, and a transmit-only voice communication session with the PSAP.

17. The storage medium of claim 14, wherein the audible or tactile stimulus corresponds to one among a stealth mode and a non-stealth mode request, and wherein the storage medium comprises computer instructions for:
establishing two-way communications with a PSAP with a speakerphone function enabled for the non-stealth mode request;
for stealth mode request,
establishing two-way communications with a PSAP with audible signals received from the PSAP muted; and
presenting by way of a speakerphone feature of the communication device audible signals received from the PSAP responsive to receiving a sequence of one or more predetermined Dual Tone Multi-Frequency (DTMF) tones.

18. The storage medium of claim 14, wherein the communication device comprises a cellular phone, a computer, a communication system in an automobile, and a set-top box for presenting multimedia services.

19. A monitoring system, comprising a controller element to receive an emergency alert signal from a cell phone having a plurality of configurable security alert options.

20. The monitoring system of claim 19, wherein the monitoring system corresponds to a Public Service Access Point (PSAP), and wherein the emergency alert signal comprises at least one among a geographic location of the cell phone, and subscriber information comprising at least one among an identity of the subscriber of the cell phone, an age of the subscriber, a gender of the subscriber, and medical information associated with the subscriber.

21. The monitoring system of claim 19, wherein the controller:
searches for one or more emergency response units closest to a geographic location supplied with the emergency alert signal;
determines from subscriber information supplied with the emergency alert signal which of the one or more emergency response units to contact; and
directs the selected emergency response unit to dispatch one or more emergency personnel to the geographic location.
